(19) United States
(12) Patent Application Publication
(10) Pub. No.: US 2007/0294122 A1
(43) Pub. Date: Dec. 20, 2007

(54) SYSTEM AND METHOD FOR INTERACTING IN A MULTIMODAL ENVIRONMENT

(75) Inventor: Michael Johnston, New York, NY (US)

Correspondence Address: AT&T CORP., ROOM 2A207, ONE AT&T WAY, BEDMINSTER, NJ, 07921, US

(73) Assignee: AT&T Corp., New York, NY (US)

(21) Appl. No.: 11/424,056

(22) Filed: Jun. 14, 2006

(51) Int. Cl. G06F 17/30

(52) U.S. Cl. 705/10

(57) ABSTRACT

A system and method of interacting in a multimodal fashion with a user to conduct a survey relate to presenting a question to a user, receiving user input in a first mode and/or a second mode, classifying the received user input on a certainty scale, the certainty scale related to a certainty of the user in answering the question and determining whether to accept the received user input as an answer to the question based on the classification of the received user input. A multimodal or single mode clarification dialog can be based on the analysis of the received user input and whether the user is confident in the answer. The question may be a survey question.

### BACKGROUND OF THE INVENTION

1. Field of the Invention

The present invention relates to a system and method of providing surveys in a multimodal environment.

2. Introduction

State and federal governments and businesses all administer surveys to the public such as the census in order to answer research questions and gather statistics. The accuracy of these surveys is critical since they have a direct impact on determination of policy, funding for programs, and business planning. Societal and technological changes, including decline in use of landline telephony and the enforcement of ‘do not call’ lists challenge the feasibility of traditional telephone-based survey techniques. New approaches to survey data collection, such as multimodal interfaces can potentially address this problem.

However, there are always challenges in determining the accuracy of the received information in a survey where the surveyor is not a person but a machine interface. Recent experimental work has shown that auditory cues (conceptual misalignment cues) correlate with uncertainty on the part of a survey respondent towards their answer. The most significant of these concerns a ‘Goldilocks’ range of response times within which the respondent is more likely to be uncertain of their response. These auditory cues help the machine system to make determinations on the accuracy of the data in a similar way that a live interviewer would recognize doubt. However, the use of live interviewers continues to become more expensive to implement. Furthermore, with a variety of people administering a survey, each person may present questions in different ways and interpret responses in different ways which jeopardizes the results. What is needed is an improved way of performing machine surveys.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Surveys such as the U.S. census gather information from users such as the number of bedrooms in their house, how many hours they worked for pay in the last week, etc. These surveys are typically administered by trained paid interviewers. The present invention relates to systems and methods for delivering a survey in an interactive multimodal conversational environment which may be administered over the Internet. The multimodal interface provides a more engaging automated interactive survey with higher response accuracy. This reduces the cost of administering surveys while maintaining participation and response accuracy.

The method embodiment relates to a method of conducting a multimodal survey. The method comprises presenting a question to a user, receiving user input in a first mode and/or a second mode, classifying the received user input on a certainty scale, the certainty scale related to a certainty of the user in answering the question and determining whether to accept the received user input as an answer to the question based on the classification of the received user input. One advantage of such a system is that in the multimodal context, the system can retrieve multiple streams of types of data input and take accuracy cues (including the ‘Goldilocks’ data for audio) from each input stream. There may also be just a single mode that the user's input is received in, such as only in a graffiti mode. The question may be a survey question.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a basic system embodiment;

FIG. 2 illustrates a basic spoken dialog system;

FIG. 3 illustrates a basic multimodal interactive system; and

FIG. 4 illustrates a method embodiment of the invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The goal of this invention is to use machine learning techniques in order to classify a respondents input to an automated multimodal survey interview system as certain or uncertain. This information can be used in order to determine whether to ask a follow up question or provide other additional clarification to the respondent before accepting their answer. The features to be used as inputs to the classification process include auditory features along with other auditory features and features from other input modalities. Information from other modalities could include mouse activity (e.g. did the respondent mouse over more than one option before making their choice), information about response to text or windows, analysis of handwritten input (e.g. speed), and input from a camera capturing the users facial expressions and body movement.

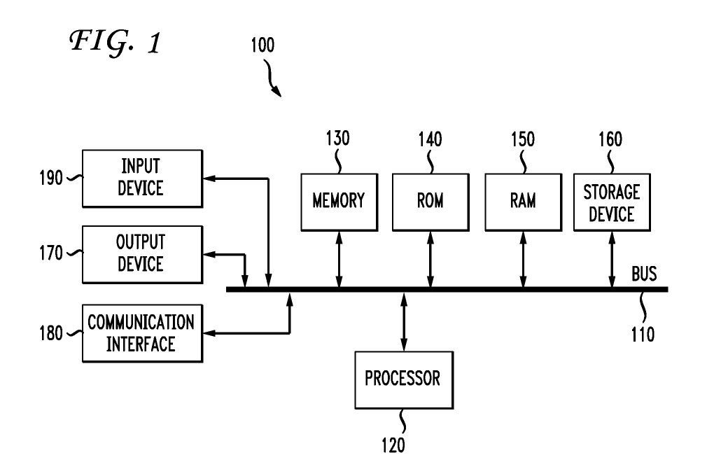

The present invention improves upon prior systems by enhancing the survey interaction and enabling a multimodal mechanism to more efficiently and accurately engage in a survey. With reference to FIG. 1, an exemplary system for implementing the invention includes a general-purpose computing device 100, including a processing unit (CPU) 120, a system memory 130, and a system bus 110 that couples various system components including the system memory 130 to the processing unit 120. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. The system may also include other memory such as read only memory (ROM) 140 and random access memory (RAM) 150. A basic input/output (BIOS), containing the basic routine that helps to transfer information between elements within the computing device 100, such as during start-up, is typically stored in ROM 140. The computing device 100 further includes storage means such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input device 190 also in the multimodal context may represent a first input means and a second input means as well as additional input means. For example, in the Multimodal Access to City Help (MATCH) application, voice and gesture input are combined into an input lattice to determine the user intent. The device output 170 can also be one or more of a number of output means. For example, in MATCH, the response to a user query may be a video presentation with audio commentary. Multimodal systems enable a user to provide multiple types of input to communicate with the computing device 100. The communications interface 180 generally governs and manages the user input and system output.

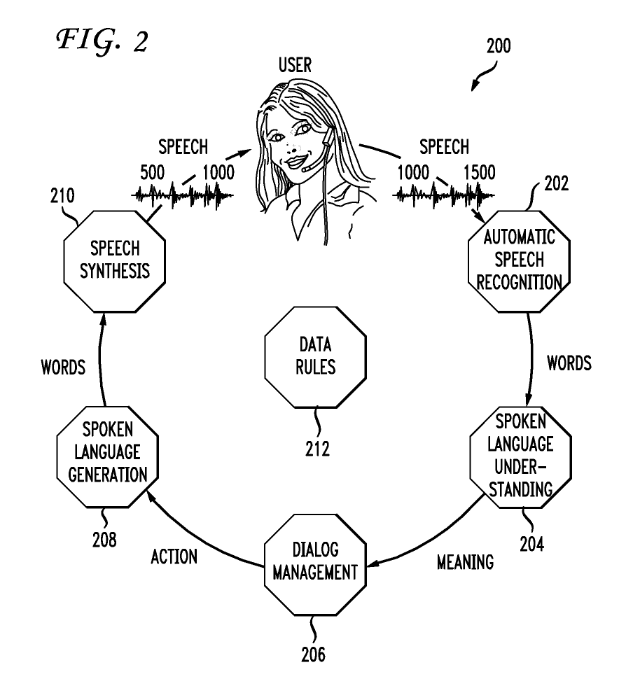

FIG. 2 illustrates a basic spoken dialog system identify the intent of a user utterance, expressed in natural language, and take actions accordingly, to satisfy the requests. FIG. 2 is a functional block diagram of an exemplary natural language spoken dialog system 200. Natural language spoken dialog system 200 may include an automatic speech recognition (ASR) module 202, a spoken language understanding (SLU) module 204, a dialog management (DM) module 206, a spoken language generation (SLG) module 208, and a speech synthesis module 210. The speech synthesis module may be any type of speech output module such as a text-to-speech (TTS) module. In another example, the synthesis module 210 may provide one of a plurality of prerecorded speech segments is selected and played to a user. Thus, this module 210 represents any type of speech output. Data and various rules 212 govern the interaction with the user and may function to affect one or more of the spoken dialog modules.

ASR module 202 may analyze speech input and may provide a transcription of the speech input as output. SLU module 204 may receive the transcribed input and may use a natural language understanding model to analyze the group of words that are included in the transcribed input to derive a meaning from the input. The role of DM module 206 is to interact in a natural way and help the user to achieve the task that the system is designed to support. DM module 206 may receive the meaning of the speech input from SLU module 204 and may determine an action, such as, for example, providing a response, based on the input. SLG module 208 may generate a transcription of one or more words in response to the action provided by DM 206. The synthesis module 210 may receive the transcription as input and may provide generated audible speech as output based on the transcribed speech.

Thus, the modules of system 200 may recognize speech input, such as speech utterances, may transcribe the speech input, may identify (or understand) the meaning of the transcribed speech, may determine an appropriate response to the speech input, may generate text of the appropriate response and from that text, may generate audible “speech” from system 200, which the user then hears. In this manner, the user can carry on a natural language dialog with system 200. Those of ordinary skill in the art will understand the programming languages and means for generating and training ASR module 102 or any of the other modules in the spoken dialog system. Further, the modules of system 200 may operate independent of a full dialog system. For example, a computing device such as a smartphone (or any processing device having a phone capability) may have an ASR module wherein a user may say “call mom” and the smartphone may act on the instruction without a “spoken dialog.”

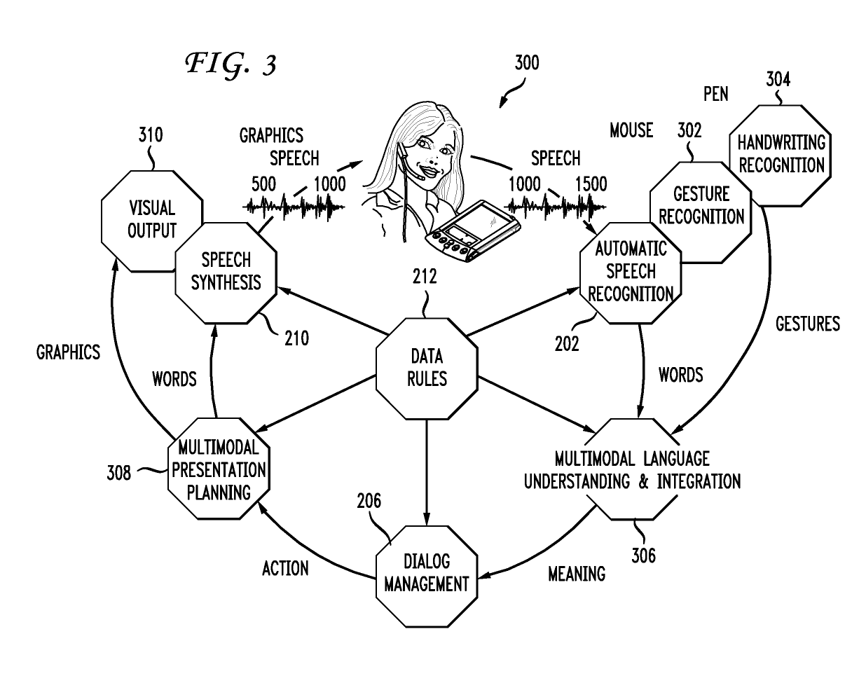

FIG. 3 illustrates a multimodal addition to the speech system of FIG. 2. In this case, more interactions are capable of being analyzed and presented. In addition to speech, gesture recognition 302 and handwriting recognition 304 (as well as other input modalities not shown) are received. A multimodal language understanding and integration module 306 will receive the various inputs (such as speech and ink) and generate independent lattices for each modality and then integrate those lattices to arrive at a multimodal meaning lattice to present to a multimodal dialog manager 206. As an example, in the known MATCH system, a user can say “how do I get to Penn Station from here?” and on a touch sensitive screen circle a location on a map. The system will process a word lattice and ink lattice and present a visual map and auditory instructions “take the 6 train heading downtown . . . .”

Over the Internet such technologies as Voice over IP, standards such as X+V, SALT and the W3C Consortium Multimodal Working Group are providing continuously improved underlying technologies for multimodal interaction. The present invention utilizes these technologies in the context of surveys or other user interaction.

An example of the system network-based embodiment consists of a series of back-end servers and provides support for speech recognition, text to speech, dialog management, and a web server. The user is presented with a graphical interface combining a graphical talking head with textual and graphical presentations of survey questions. The graphical interface is accessed over the web from a browser. The user interface is augmented with a SIP (session initiation protocol) client which is able to establish a connection from the browser to a voice XML server providing access to speech recognition and text to speech capabilities. The system presents the user with each question in turn and allows the user to answer using speech or the graphical interface. The system is able to provide clarification to the user using different modes such as speech or graphics, or combinations of the two modes.

The challenge with a web based approach that does not utilize speech is that certain features of the speech (misalignment cues) that can he used to predict the accuracy of interviewer responses are absent. Research has shown that in web interactions, users are less likely to seek clarification of concepts when they are giving rather than obtaining information, and this can have an adverse impact on response accuracy. Another alternative is to administer surveys using an automated telephone system (cf. How May I Help You, and VoiceTone for customer service). This approach also does not require human interviewers but faces a number of problems. First, speech only conversational interaction can be lengthy and cumbersome for respondents. Secondly, spoken interaction is subject to frequent errors and with the speech-only system there is not alternative but to confirm verbally. Third, the speech-only interface does not enable the system to present options in parallel and the information presented is not persistent. Recent technological advances which enable integration of spoken interaction using VOIP with web-based graphical interaction will enable the creation of a new kind of automated survey presented herein which combines the benefits and overcomes the weaknesses of the purely web based or telephone based alternatives.

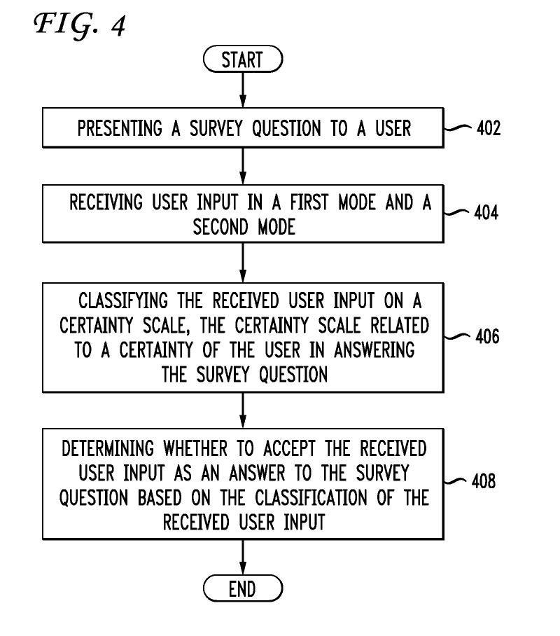

The method embodiment is shown in FIG. 4. A method of conducting a multimodal survey comprises presenting a question to a user (402), receiving user input in a first mode and/or a second mode (404), classifying the received user input on a certainty scale, the certainty scale related to a certainty of the user in answering the question (406) and determining whether to accept the received user input as an answer to the question based on the classification of the received user input (408). The first mode and the second mode each relate to at least one of: auditory input, mouse activity, text field entry activity, graffiti input and camera input. Thus the user input is preferably in at least two modes. However, it may be one non-speech mode such as gesture input. If the user input is only gesture or one other non-speech mode, then an attempt is made to characterize and analyze the input to determine accuracy. For example, does the user run the mouse over several different options before selecting option B. How much time does the user take, does the user shake the mouse before making a decision, and so forth. Any type of interaction in one or more modes may be studied for accuracy cues. The certainty scale may relate to at least one of: a speed associated with the received user input, graphical movement associated with the received user input, and body features or movement of the user. The body features of the user are at least a facial expression of the user. Other features may be body temperature or moisture.

Another aspect of the invention is where the user input is received in a single mode. This may be, for example, in an audio, video, motion, temperature, graffiti, text input, etc. mode. Any of these modes individually may provide data related to the user's certainty of an answer. Therefore, where the user's input is in a single mode the system can receive that single mode input and analyze it for the certainty calculus which then affects the other processes in the dialog.

The multimodal interaction may be performed for any reason. For example, the preferred use of the invention is for survey questions but any kind of question or system input to the user may be used. For example, the term “question” may refer to a graphical, audio, video, or any kind of presentation to a user which requires a user response.

If the classifying step determines that the user input should not be accepted, then the method further comprises presenting further information seeking clarification of a user response. The rules and data module 212 may work with the DM module 206 to tailor the clarification presentation based on the type of data. For example, if the cue of doubt in the user response is head movement, perspiration or increased body temperature, the clarification dialog may be different than if the cue is mouse movement or graffiti input cues. This may be for several reasons, such as certain types of cues indicate less of doubt and more of deception. Thus, the clarification may have a goal of drawing out whether the user is being deceitful rather than simply in doubt as to an answer.

There are many advantages to the multimodal interactive system for a survey interface. The system can engage in the clarification dialog to overcome the conceptual misalignments or deception, there may be parallel and persistent presentation of information, faster user interaction, and enabling users to switch modes to avoid recognition errors. The experience (survey) can be taken any time by the user and a multimodal experience will be more interesting and engaging to the user. The graphical interface will allow for presentation of clarification prompts with multiple options without long and unwieldy prompts as would occur in a purely vocal environment. Further, the multimodal approach enables survey content to be presented and expressed in the most appropriate mode for the content, whether it is speech or graphical content with speech. Further, the multiple modes enable users to employ the best mode suited to their capabilities and preferences. With these improvements, not only can the doubt cues be interpreted in different modes but the users will be more likely to use the system such that more surveys can be accomplished.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, while the preferred embodiment is discussed above relative to survey interactions, the basic principles of the invention can be applied to any multimodal interaction, such as to order travel plans or to look for the location of restaurants in New York. Accordingly, the appended claims and their legal equivalents should only define the invention, rather than any specific examples given.

We claim:

1. A method of conducting multimodal interaction with a user, the method comprising:
presenting a question to a user;
receiving user input in a first mode and a second mode;
classifying the received user input on a certainty scale, the certainty scale related to a certainty of the user in answering the question; and
determining whether to accept the received user input as an answer to the question based on the classification of the received user input.

2. The method of claim 1, wherein the first mode and the second mode each relate to at least one of: auditory input, mouse activity, text field entry activity, graffiti input and camera input.

3. The method of claim 1, wherein the certainty scale relates to at least one of: a speed associated with the received user input, graphical movement associated with the received user input, and body features of the user.

4. The method of claim 3, wherein the body features of the user are at least a facial expression of the user.

5. The method of claim 3, wherein the body features of the user are at least movement of the user.

6. The method of claim 1, wherein if the classifying step determines that the user input should not be accepted, then the method further comprises: presenting further information seeking clarification of a user response.

7. The method of claim 1, wherein the question is a survey question.

8. A computer-readable medium storing instructions for controlling a computing device to conduct a multimodal interaction with a user, the instructions comprising:
presenting a question to a user;
receiving user input in a first mode and a second mode;
classifying the received user input on a certainty scale, the certainty scale related to a certainty of the user in answering the question; and
determining whether to accept the received user input as an answer to the survey question based on the classification of the received user input.

9. The computer-readable medium of claim 8, wherein the first mode and the second mode each relate to at least one of: auditory input, mouse activity, text field entry activity, graffiti input and camera input.

10. The computer-readable medium of claim 8, wherein the certainty scale relates to at least one of: a speed associated with the received user input, graphical movement associated with the received user input, and body features of the user.

11. The computer-readable medium of claim 10, wherein the body features of the user are at least one of: a facial expression of the user or movement of the user.

12. The computer-readable medium of claim 8, wherein if the classifying step determines that the user input should not be accepted, then the method further comprises: presenting further information seeking clarification of a user response.

13. The computer-readable medium of claim 8, wherein the question is a survey question.

14. A system for conducting multimodal interaction with a user, the system comprising:
a module configured to present a question to a user;
a module configured to receive user input in a first mode and a second mode;
a module configured to classify the received user input on a certainty scale, the certainty scale related to a certainty of the user in answering the question; and
a module configured to determine whether to accept the received user input as an answer to the question based on the classification of the received user input.

15. The system of claim 14, wherein the first mode and the second mode each relate to at least one of: auditory input, mouse activity, text field entry activity, graffiti input and camera input.

16. The system of claim 14, wherein the certainty scale relates to at least one of: a speed associated with the received user input, graphical movement associated with the received user input, and body features of the user.

17. The system of claim 16, wherein the body features of the user are at least a facial expression of the user.

18. The system of claim 16, wherein the body features of the user are at least movement of the user.

19. The system of claim 14, wherein if the classifying step determines that the user input should not be accepted, then the method further comprises: presenting further information seeking clarification of a user response.

20. The system of claim 14, wherein the question is a survey question.
